(19) United States
(12) Patent Application Publication
(10) Pub. No.: US 2021/0019777 A1
(43) Pub. Date: Jan. 21, 2021

(54) METHOD OF PROMOTING BUSINESS BY CONDUCTING FREQUENT FREE-PLAY NUMBER DRAWINGS AND AWARDING CASH PRIZES

(71) Applicant: ALAN FRANK, PITTSBURGH, PA (US)

(72) Inventor: ALAN FRANK, PITTSBURGH, PA (US)

(21) Appl. No.: 16/511,763

(22) Filed: Jul. 15, 2019

(51) Int. Cl. G06Q 30/02; G06K 9/00

(52) U.S. Cl. CPC G06Q 30/0209; G06K 9/00255; G06Q 30/0236; G06Q 30/0239

(57) ABSTRACT

This invention comprises a method of attracting customers to retail businesses by conducting lucky number drawings on the business premises every ten minutes. Visitors can enter the drawings without purchasing or paying anything by scanning the 2D barcodes on their photo-ID documents, which can be issued by the merchant. System software uses the date of each scan and the decoded identification information represented by the barcode to prevent visitors from entering drawings more often than once a day. Entrants can select multiple four-digit numbers at selection stations. All entrants whose selected numbers become matched by the next randomly generated winning number receive valuable prizes if their faces match their photo-IDs.

### BACKGROUND OF THE INVENTION

This invention relates generally to systems for promoting retail business and particularly to the operation of free number drawings at frequent intervals throughout the day in retail stores. The system will be most effective for attracting traffic to brick and mortar retail businesses but can also be used to promote internet business.

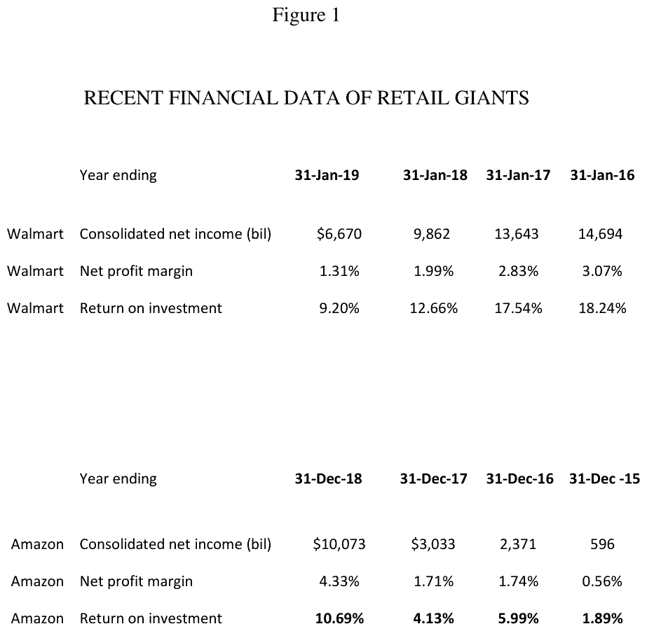

Major retailers are constantly searching for innovative promotional systems that will help retain and expand their customer bases. Retail giants like Walmart are struggling to compete with internet giant Amazon. They all crave novel promotional systems. The table in FIG. 1 indicates their recent economic performances.

For maximum effectiveness, a promotional system should operate automatically and continuously. It must be available to paying and non-paying shoppers. The system should include some suspense, anxiety and surprise, and should require minimum effort.

Periodic sweepstakes and contests have only been moderately effective in generating traffic and increasing retail sales. Traditional methods of offering discounts and special sales do not seem to be as effective as of late. Providing retail shoppers with free door prizes would attract shoppers, but would lead to abuse, inasmuch as opportunists would take advantage of the ability to re-enter the doors repeatedly. Accordingly, a need exists for a novel type of business promotion that that includes anxiety and surprise, that requires little effort, that is free, that awards valuable prizes, that does not require human intervention, but is not susceptible to quick replay.

Live draw bouncing ball number guessing games produce uncertainty, anxiety and surprise, and have achieved a high level of popularity and respectability. Historically, the numbers on the balls were identified by human eyes as described in U.S. Pat. No. 4,601,471. The necessity of human intervention was almost eliminated by using bar-coded balls as described in U.S. Pat. No. 5,088,737. The necessity of human observation was finally eliminated by using differently colored balls as described in U.S. Pat. No. 9,751,002-B. With that invention, automatic live draw generation of random numbers without human eye identification finally became a reality.

The major problem with automatic free number drawings that award valuable prizes however is their vulnerability to quick replay by opportunists. A need therefore exists for a method of operating automatic, free number drawings that cannot be quickly re-played. The current invention satisfies that need by making a novel use of the 2D barcode which has recently become widely used and respected. 2D barcode scanners can easily be programmed to select fields of text on a remote document and transfer them to an open “Excel” or “Word” document.

To reach its maximum potential as a business promotion system, free number drawings should operate frequently all day every day, 24×7×365. The random number generating process should be “live-draw,” completely visible at all times, and should be free of human intervention and completely automatic. All those features enhance public trust.

The time span between generating new winning numbers should be brief enough to give the participants prompt satisfaction but should not be so brief as to destroy all chances of selling the potential shoppers some merchandise. Accordingly, in one embodiment of the current invention the time span between drawings is set at ten minutes. In a 24-hour period, there will be 144 drawings.

The current invention also addresses the issue of establishing the optimum prize amount. Assuming the average sales receipt issued by a major retail merchant is about $50.00, and further assuming that its net profit per sale is about 2% of the sale price, the major retail merchant's profit is about $1.00 per sale. Assuming about 20,000 sales per week, the merchant's net profit would be $20,000.00 per week.

A major merchant will be willing to risk 5%-10% of its profits on a promising new promotion. Accordingly, for such merchants, prizes of about $2,000.00 per week are established as a starting point.

The next step is to determine the optimum number of digits the winning number should have. If half of the merchant's 20,000 weekly paying customers entered the drawings and another 10,000 non-paying visitors entered, there would be 20,000 entries per week. With three-digit drawings, there will be one winner every 1,000 plays or 20 winners every 20,000 plays. If each winner received a prize of $1,000.00, the total prize payout would be $20,000.00. That would consume the merchant's entire weekly profit. Accordingly, use of a three-digit winning number would not be feasible.

If a four-digit number is used, there will be an average of two winners per week. Accordingly, the current invention favors a four-digit winning number as optimal. Essentially, the promotion will cost the merchant about $2,000.00 per week, which will amount to about ten percent of a major merchant's net profits.

Entrants who select only one four-digit number will win $1,000.00 if their selected number becomes matched by the next randomly generated winning number. Entrants who select ten four-digit numbers will win $100.00 if one of their selected numbers becomes matched by the next randomly generated winning number.

An increase of 10% of the merchant's shopper base is a realistic expectation from the current invention. When 10% of the merchant's 10,000 non-purchasing entrants become paying customers, the merchant's net profits will increase by about $1,000.00 per week. As soon as the promotion attracts 2,000 new weekly customers, it will be self-sustaining. The upside is unlimited. The only uncertainty is how long it will take for the promotion to sustain itself.

### SUMMARY OF THE INVENTION

This invention includes networked number selection stations that consist of alpha-numeric keypads, display screens, barcode scanners, and ticket printers. To enter a drawing, a visitor must scan the 2D barcode strip on the back of his/her driving license or on a photo-id card issued by the merchant. The scan is date stamped. The ID information represented by the 2D barcode is stored on a central server. That information enables the software on a central server to prevent use of the same license or photo-ID card more often than once a day.

The scanners can be configured to capture all or any of the fields of data represented by the 2D barcode on a photo-ID card and instantly display said data in any sequence or format in an open document of the program “WORD”. When a license or photo-ID card_is scanned, its ID number and the first name of the licensee appear on the display screen. The scanners transmit all captured data to the central server which adds it to permanent storage.

Entrants can select as many as ten four-digit numbers. Mobile devices such as i-phones that contain customized applications can be used to perform many functions. The screen then displays how much money the entrant will win if any of her/his selected numbers becomes matched by the next randomly generated four-digit number. If one of the selections becomes matched by the next randomly generated four-digit number, the entrant wins $1,000.00 divided by the quantity of numbers the entrant selected.

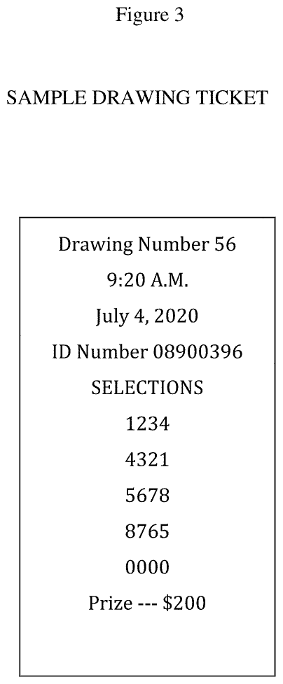

When satisfied with his/her selections, the entrant touches the submit button. The printer prints a ticket containing the entrant's ID number, the numbers the entrant selected, the time and date, the sequential number of the next drawing, and the prize amount. (FIG. 3) The ticket has no redemption value but gives the entrant a reminder to hold while rooting for a win.

Within ten minutes after an entrant submits his/her selections, the system automatically and randomly generates the four digits of a new winning number. The apparatus and software described in U.S. Pat. No. 9,751,002 B and the mixing chambers described in U.S. Pat. No. 4,601,471 function as the preferred random number generating system for the current invention. Other random number generating systems will suffice.

### BRIEF DESCRIPTION OF THE DRAWINGS

### New Sheet of Drawings

FIG. 1 is a table that indicates the financial progress of retail giants Walmart and Amazon over the past four years.

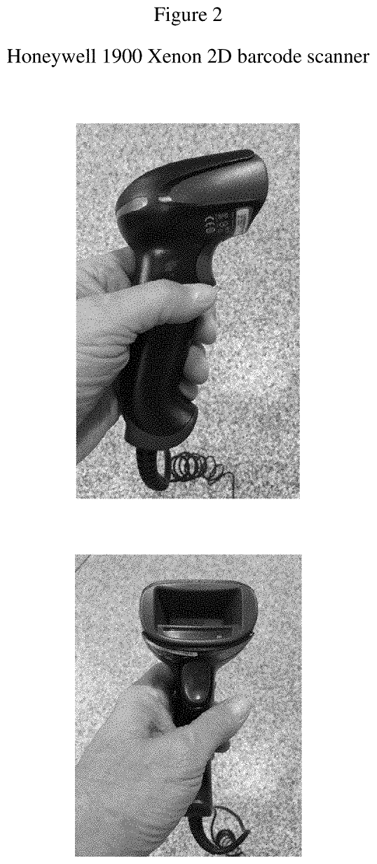

FIG. 2 displays images of a Honeywell 1900 Xenon 2D barcode scanner

FIG. 3 displays a typical ticket issued to an entrant that contains the entrant's number selections

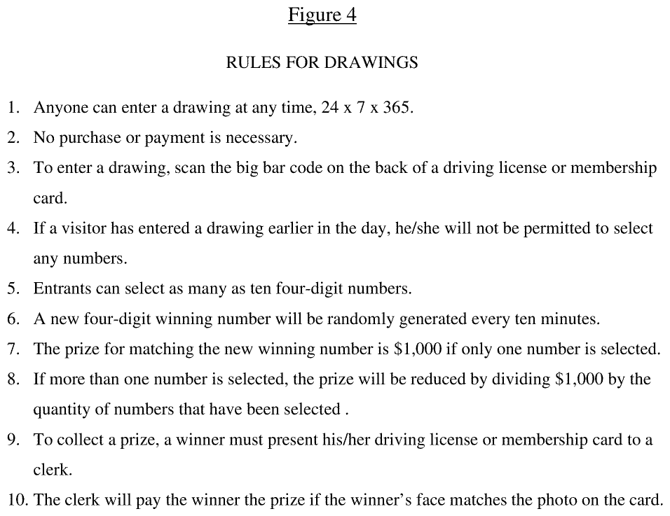

FIG. 4 displays the Rules for the drawings

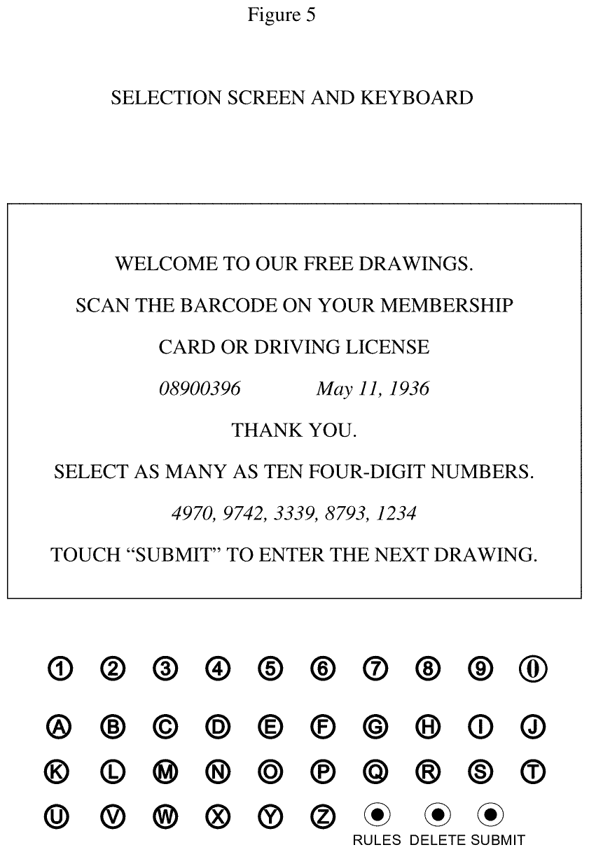

FIG. 5 displays the keypad and display screen of a number selecting station.

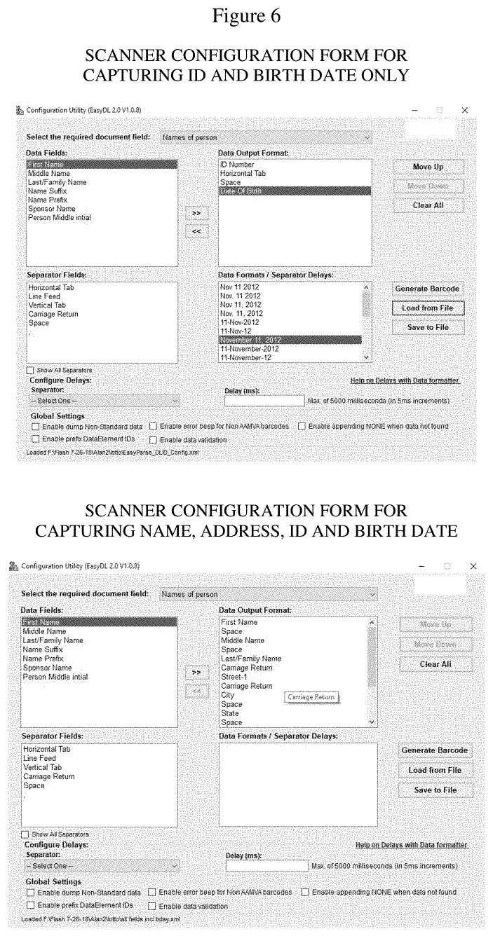

FIG. 6 displays two different sample screen shots of the fillable form of the scanner configuration software.

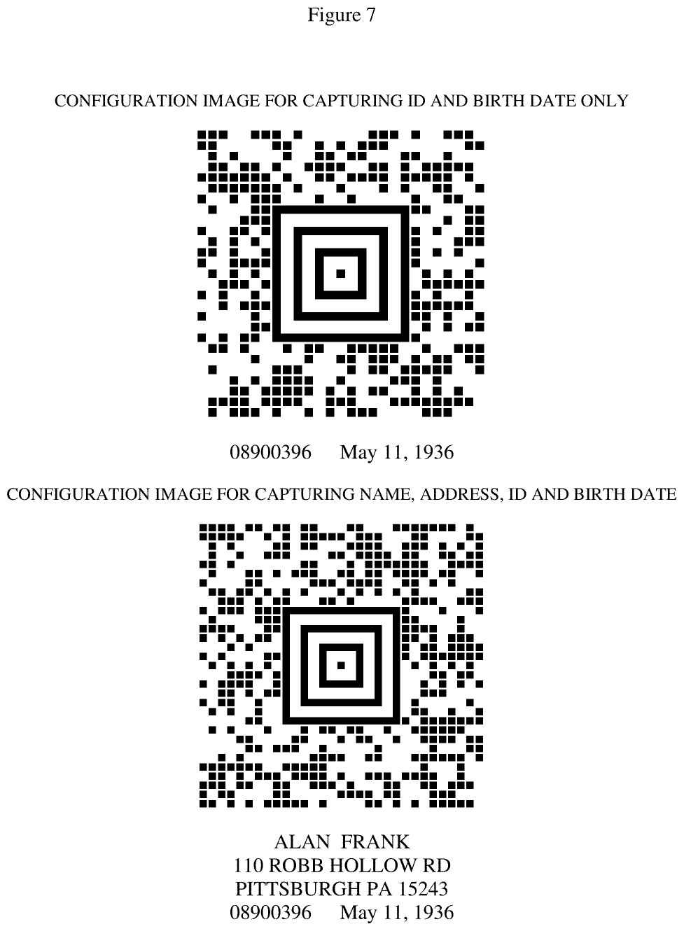

FIG. 7 displays two images that are generated during configuration of the scanner to capture either the ID number and birth date of the visitor or the name, address, ID number and birth date.

### DETAILED DESCRIPTION OF THE INVENTION

Each number selection station consists of:
1. a Honeywell 1900 Xenon 2D barcode scanner.
2. a printer that dispenses a ticket displaying the date, time, game number, ID number, selected numbers and prize amount.
3. an alpha-numeric keypad and display screen

In order to configure a Honeywell 1900 scanner, Easy DL™ configuration software must be installed on a personal computer. It can be downloaded by clicking the following link. EasyDL2.0 ConfigUtility V108(2).zip. Installation of the software is routine and requires less than a minute.

The software opens with a fillable form (FIG. 6) that includes various data fields. Any data field that the merchant desires to capture can be isolated and designated for display on an open WORD or EXCEL document in any sequence or format.

In one sample configuration process, the “Customer ID number” and “birth date” data fields in the fillable form of the software were isolated. (FIG. 6, top) By clicking the “Generate Barcode” button on the fillable form, a configuration image (FIG. 7, top) was instantly generated and displayed on the computer screen.

The bottom of FIG. 7 displays the fillable form for an alternate configuration. The first name, middle name, last name, street address, city, state, postal code, Customer ID number and birth date data fields were isolated. The software then generated the configuration image shown in the bottom of FIG. 7. When the scanner scanned said onscreen image, it instantly became configured to capture all the foregoing data fields.

To enter a drawing, a visitor must scan his/her photo ID card. The visitor's name will appear on the screen and will be recorded on the spread sheet which resides on the central server. The spread sheet contains data for the drawings held in the previous 24 hours.

Upon receipt of an ID number from a number selection station, the central server instantly searches the column of the spread sheet that contains the ID numbers of all visitors who have entered a drawing in the same day. If the ID number is found, the following message will appear on the play station screen.

Please Try Again Tomorrow

If the visitor has not entered a drawing earlier in the same day, and his/her ID number is not found on the spread sheet, the display screen will welcome the visitor to enter as many as ten four digit numbers. When satisfied with his/her selections, the display will notify the entrant to touch the SUBMIT button. When the SUBMIT button is touched, the printer will print out a paper ticket (FIG. 3) that shows the entrant's ID number, his/her number selections, the time and date, the sequential number of the next drawing and the entrant's prize amount. Within 10 minutes, the random number generator will generate a four-digit number. It will be displayed on large overhead monitors and announced on speakers.

After each winning number is randomly generated, the server software searches the spread sheet for the current game. If one or more of the selected four-digit numbers in the spread sheet match the new randomly generated winning number, the server software identifies the ID numbers of those entrants who selected them and determines the prize amount each entrant will win.

Each entrant who selected the number that became matched by the randomly generated winning number must present his/her photo-ID card to the pay-out clerk, who will personally verify that the entrant's face matches the face on his/her photo-id card. The software on the server will cause the pay-out clerk's screen to display how much to pay to each winner.

Initially, there will be one random number generator in each store of a chain of stores of a major retailer. After some field experience, a major retailer can choose to use one central random number generator that will produce a random four-digit number every ten minutes around the clock, for all stores in its chain. Each random generation of each new winning number will be displayed on the retailer's web page, live, and electronically disseminated to each of the stores in its chain.

Eventually, the merchant will transmit a live views of the winning numbers being generated to licensed non-competing retailers around the world, so that they can conduct their own number drawings and rely upon a universally accepted and respected string of randomly generated numbers around the clock.

The novel concept of limiting the frequency of participating in free drawings and the method of doing it, as described in this application, distinguish the current invention from all prior art.

48-57. (canceled)

58. A method of attracting customers to brick and mortar retail businesses, said method comprising the following steps:
a. Conduct lucky number drawings on the business premises.
b. Award valuable prizes to winners of said drawings.
c. Permit visitors to enter said drawings and to select their favorite numbers without paying or purchasing anything.
d. Prevent visitors from entering more than one drawing per day by taking the following steps:
i. Obtain identification information from each visitor who desires to enter said drawings;
ii. Save said identification information on a central server;
iii. Create a separate 2D barcode for each visitor, said separate 2D barcode representing each visitor's unique identification information.
iv. Create a pocket-sized durable document for each said visitor;
v. Print said 2D barcode on said visitor's durable document;
vi. Take a photo of each visitor's face;
vii. Print said photo of each visitor's face on said visitor's durable document;
viii. Give said document to said visitor;
ix. As a condition for entering the drawings, require visitors to scan any 2D barcode that represents the visitor's identification information;
x. Program the scanners that scan said barcodes to decode said 2D barcode and to transmit each item of each visitor's identification information to said central server;
xi. Maintain a data base containing the date of each said scan and each visitor's identification information.
xii. Run software that prevents a visitor from entering a drawing if the date said visitor scans his/her 2D barcode is the same as the date said barcode was previously scanned.
e. After entering a drawing, enable an entrant to select his/her favorite numbers.
f. Award said valuable prizes to entrants whose selected numbers become matched by a subsequently drawn winning number only if their faces match the photos on their photo-id documents.

59. The method described in claim 58 also including the step of enabling visitors to enter drawings and select numbers with their mobile devices.

60. The method described in claim 58 wherein said drawings are conducted frequently.

61. The method described in claim 58 wherein the winning numbers for said drawings are generated randomly and automatically.

62. The method described in claim 58 wherein generation of the winning numbers for said drawings is performed by mixing differently numbered tangible objects.

63. A method of attracting customers to brick and mortar retail businesses said method comprising the following steps:
a. Frequently conduct lucky winning number drawings on the business premises;
b. Obtain identification information and take facial photographs of visitors who desire to enter said drawings;
c. Issue photo-ID documents that are imprinted with said photographs and with 2D barcodes that represent said identification information of the photographed visitors;
d. Store said identification information on a central server;
e. Permit visitors to enter said drawings and select numbers without purchasing or paying anything;
f. Require visitors to scan the 2D barcodes on their photo-ID documents as a prerequisite for entering said drawings;
g. Establish a predetermined number of intervening drawings that must occur before a visitor can enter another drawing;
h. Store software on said server, said software preventing a visitor from entering a drawing if said predetermined number of intervening drawings have not occurred since said visitor previously entered a drawing;
i. Award valuable prizes to all entrants whose selected numbers become matched by the next randomly drawn lucky winning number and whose faces match the faces on their photo-id documents.

64. The method described in claim 63 wherein the winning numbers for said drawings are generated randomly and automatically.

65. The method described in claim 63 wherein generation of the winning numbers for said drawings is performed by mixing differently numbered tangible objects.

66. Apparatus and software comprising:
a. Means for creating a 2D barcode that represents each item of a person's identification information;
b. Means for imprinting said 2D barcode on a pocket-sized durable document;
c. Means for taking a photo of a person's face;
d. Means for imprinting said photo on said durable document that contains said 2D barcode;
e. Means for entering drawings, said means comprising barcode scanning means;
f. Number selecting means comprising information inputting means and display means;
g. Central server means for receiving and storing said information and for hosting software;
h. Software means for decoding said 2D barcodes and for transmitting the data represented by said 2D barcode to said central server means;
i. Software means for determining when each 2D barcode is scanned, said software preventing a person from entering a drawing if the date said person scans his/her 2D barcode is the same as the date said 2D barcode was previously scanned.
j. Software means for preventing a person from entering a drawing if a predetermined number of intervening drawings have not occurred since said person previously entered a drawing;

67. The apparatus and software described in claim 66 also comprising software means for enabling people to select numbers with their mobile devices.

68. The apparatus and software described in claim 66 also comprising means for conducting drawings automatically.

69. The apparatus and software described in claim 66 also comprising means for mixing differently numbered tangible objects and randomly allowing one of said objects to separate itself from the others automatically.
